(19) United States
(12) Patent Application Publication
(10) Pub. No.: US 2009/0243160 A1
(43) Pub. Date: Oct. 1, 2009

(54) Bicycle Cranks Composed of Composite Material and Metal Parts and Method for Making the Same

(76) Inventor: Douglas Chiang, Wufeng Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/479,890

(22) Filed: Jun. 8, 2009

Related U.S. Application Data
(63) Continuation-in-part of application No. 11/352,242, filed on Feb. 13, 2006.

(51) Int. Cl. B29D 22/00

(52) U.S. Cl. 264/523

(57) ABSTRACT

A method for making a crank of a bicycle includes preparing a first prepreg material and a second prepreg material, a first connector and a second connector, and a bladder in a mold insert. The first and second connectors are separated from each other. The first and second connectors are buried in the first prepreg material and includes an extension extended between the first and second connectors. The bladder is curved around the first prepreg material. The first prepreg material, the first and second connectors are buried in the second prepreg material. Then, heat-pressing the first and second prepreg materials, the first and second connectors, and the bladder.

### CROSS REFERENCE

The present application is a continuation-in-part application of U.S. patent application Ser. No. 11/352,242, filed on Feb. 13, 2006, of which the entire disclosure is incorporated herein.

### BACKGROUND OF THE INVENTION

1. Field of the Invention

The present invention relates to a method for making a crank.

2. Description of the Related Art

It is a current trend to make a bicycle crank from carbon-fiber composite material.

A carbon-fiber bicycle crank generally has a five communication tube connected to each end thereof. However, connections therebetween are not good due to that the carbon fiber composite material is very hard and brittle. To strengthen the structure, the crank generally has metal tubes mounted at pivotal connections. Furthermore, carbon-fiber sheets are adhered on the crank to fix the metal tubes with the crank.

To that end, the conventional crank often suffers a structure defect, and it is time consuming during manufacturing. Another problem is that the interior of the crank must be formed with supporting blocks for adhering operation and this incurs increased weight to the crank. Also, when the crank is complete, the metal tubes are buried. However, connection of the crank with the two metal tubes is not solid and strong. Although adhesive is used to increase the connection, the adhesive suffers a problem of buckling. Furthermore, it is difficult to prepare the adhesive.

The present invention is, therefore, intended to obviate or at least alleviate the problems encountered in the prior art.

### SUMMARY OF THE INVENTION

According to the present invention, a method for making a crank of a bicycle includes steps 1) preparing a first prepreg material and a second prepreg material, a first connector and a second connector, and a bladder in a mold insert. The first and second connectors are separated from each other. The first and second connectors are buried in the first prepreg material and includes an extension extended between the first and second connectors. The bladder is curved around the first prepreg material. The first prepreg material, the first and second connectors are buried in the second prepreg material. 2) heat-pressing the first and second prepreg materials, the first and second connectors, and the bladder.

It is an object of the present invention to provide a method for making a light-weight, strong crank against buckling.

It is a further object of the present invention to provide a method for making an economical crank.

It is yet another object of the present invention to provide a simple method for making a crank.

### BRIEF DESCRIPTION OF THE DRAWINGS

FIG. 1 is a flow chart of a method for making a crank in accordance with the present invention.

FIG. 2 is cross-sectional view showing a first prepreg material and a second prepreg material, a first connector and a second connector, and a bladder mounted in a mold insert.

FIG. 3 is a cross-sectional view showing the first and second prepreg materials, the first and second connectors, and the bladder subject to a heat-pressing process.

FIG. 4 is another cross-section view showing the first and second prepreg materials, the first and second connectors, and the bladder subject to a heat-pressing process.

FIG. 5 is a perspective view showing the crank of the present invention.

FIG. 6 is a cross-sectional view of the crank taken along line 6-6 of FIG. 5.

### DETAILED DESCRIPTION OF THE PREFERRED EMBODIMENT

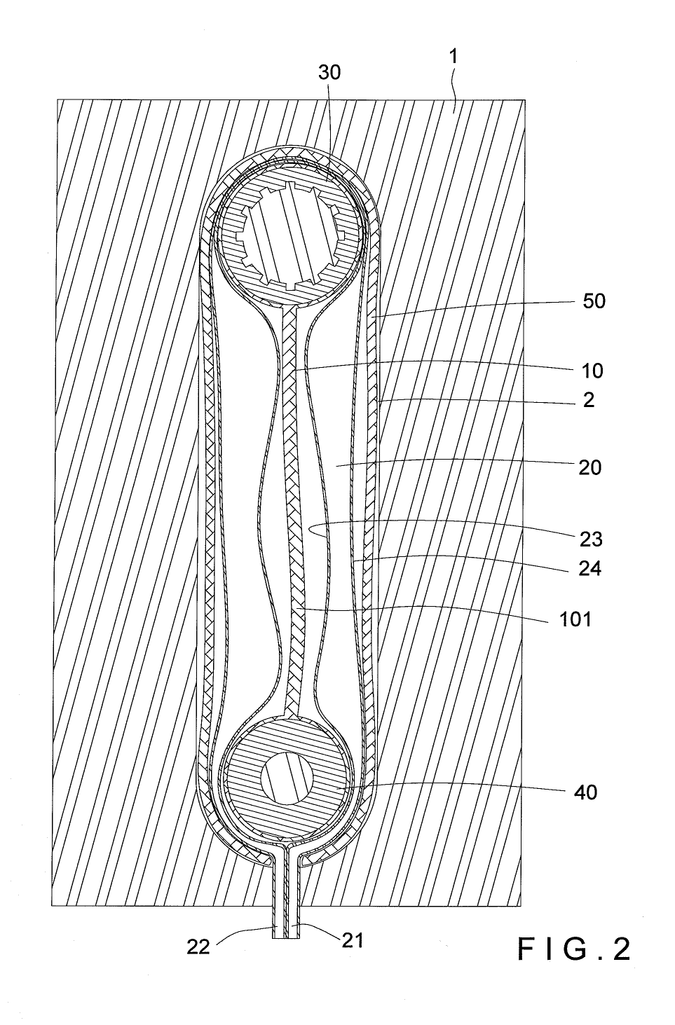

FIG. 2 shows a first prepreg material 10 and a second prepreg material 50, a first connector 30 and a second connector 40, and a bladder 20 for making a crank of the present invention. The first and second prepreg materials 10 and 50, the first and second connectors 30 and 40, and the bladder 20 are mounted in a cavity 2 of a mold insert 1. The mold insert 1 may be configured of two complemently fitted mold inserts 1, and the cavities 2 of the respective mold inserts 1 are configured to correspond to each other. Additionally, the first 30 and second 40 connectors are disposed separately and are buried by the first prepreg material 10 such that the first prepreg material 10 encompasses a respective outer periphery of the first 30 and second 40 connectors and have an extension 101 extended between the first 30 and second 40 connectors. Thus, the prepreg material 10 and the first 30 and second 40 connectors have a sufficient joining area to prevent detachment therebetween, and the extension 101 of the prepreg material 10 not only supports the first 30 and second 40 connectors but prevents the crank of the present invention against buckling. Further, the bladder 20 having an inlet opening 21 and an outlet opening 22 communicated with each other is curved around the first prepreg material 10 and the first 30 and second 40 connectors such that the bladder 20 has one portion disposed on a right side of the first prepreg material 10 and another portion disposed on a left side of the first prepreg material 10. Further, the inlet opening 21 and the outlet opening 22 open towards the same direction. Furthermore, the first prepreg material 10, the first 30 and second 40 connectors, and the bladder 20 are buried in the second prepreg material 50.

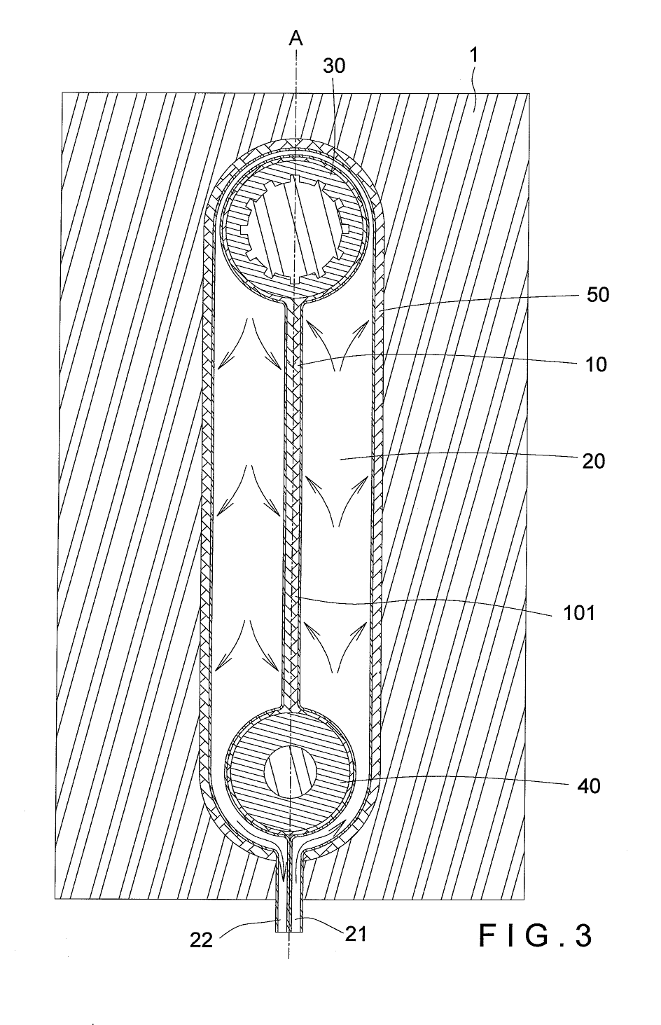

FIG. 3 shows the first 10 and second 50 prepreg materials, the first 30 and second 40 connectors, and the bladder 20 subject to a heat-pressing process. During the process, air is pumped continuously into the bladder 20 and inflates the bladder 20 and causes an inner peripheral face 23 of the bladder 20 to press the first prepreg material 10 and make extension 101 of the first prepreg material 10 symmetrically disposed with respect to a center line A, and the inner peripheral surface 23 of the bladder 20 is compactly fitted with the first prepreg material 10. Additionally, the bladder 20 causes an outer peripheral face 24 thereof to compactly fit with the second prepreg material 50 and the second prepreg material 50 to abut against the periphery of the cavity 2. Furthermore, the reason that the first prepreg 10 material is symmetrically disposed with respect to the center line A is because air within the bladder 20 on the right side of the first prepreg material 10 and air within the bladder 20 on the left side of the first prepreg material 10 impart equal pressure.

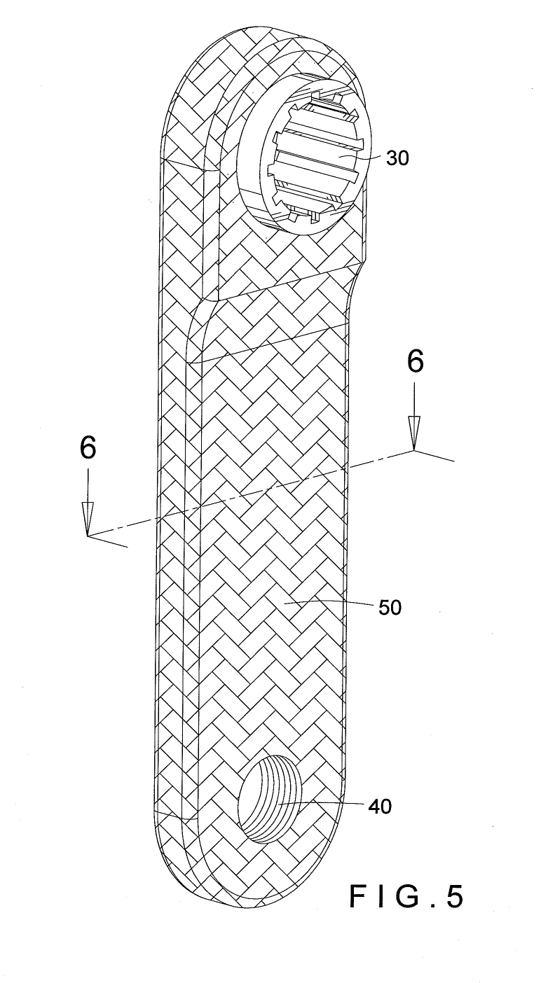

After the heat-pressing process, the prepreg material 10 and the first 30 and second 40 connectors are snugly covered up by the second prepreg material 50, and the first 10 and second 50 prepreg materials become solid, as shown in FIG. 5.

When in use of the crank, the first connector 30 and the second connector 40 are utilized to connect with a transmission gear of a bicycle and a pedal, respectively. It is understood that rider can operate the pedal to turn the crank and the crank can control rotation of the transmission gear. The first 30 and second 40 connectors are preferably made of metal.

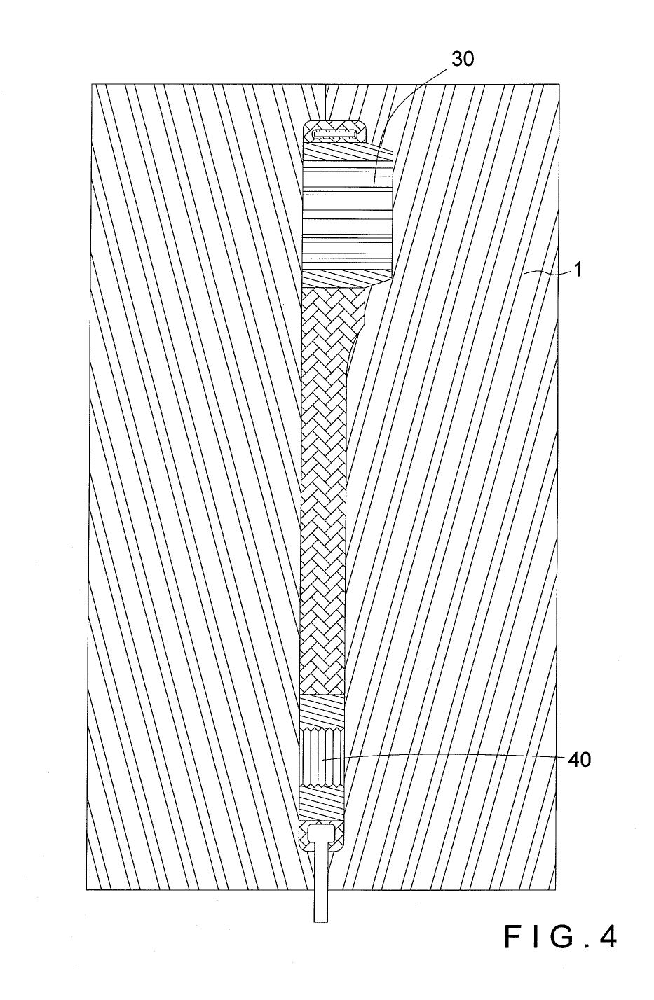

In addition, FIG. 4 shows the second prepreg material 50 has a gap at the inlet 21 opening and the outlet opening 22 of the bladder 20, whereas FIG. 5 shows the gap is filled up, this is because an additional prepreg material is utilized to fill up the gap for improved visual-pleasing effect and strength of the crank.

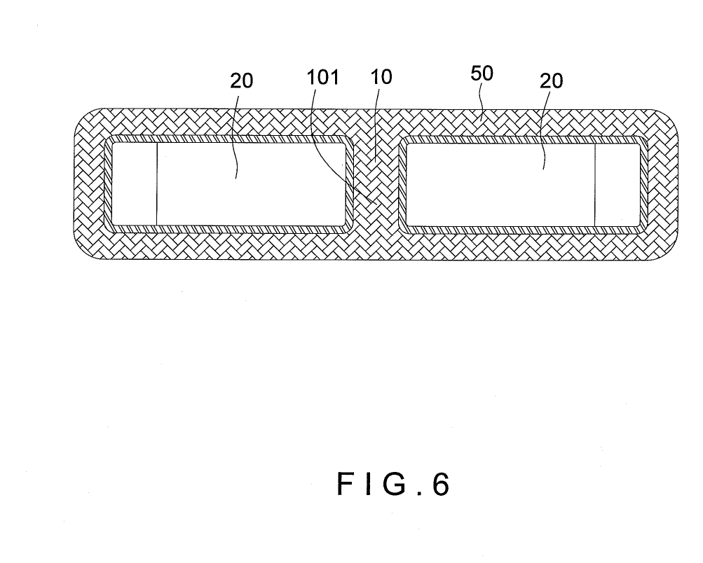

FIG. 6 is a cross-sectional view of the crank in according to the present invention. It can be seen that the bladder 20 has one portion disposed on the right side of the first prepreg material 10 and another portion disposed on the left side of the first prepreg material 10.

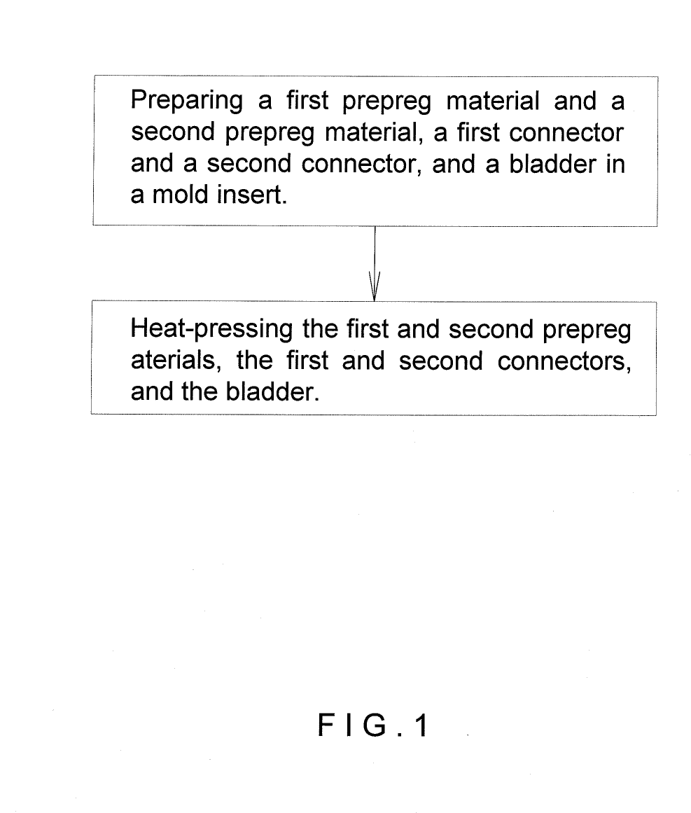

Referring to FIG. 1, a flow chart of a method for making a crank in accordance with the present invention includes 1) preparing a first prepreg material 10 and a second prepreg material 50, a first connector 30 and a second connector 40, and a bladder 20 in a cavity 2 of a mold insert 1, with the first 30 and second 40 connectors buried in the first prepreg material 10, with the first 30 and second 40 connectors separate from each other, with the prepreg material 10 including an extension 101 extended between the first 30 and second 40 connectors, with the bladder 20 curved around the first prepreg material 10 and the first 30 and second 40 connectors and having a first portion disposed on a right side of the first prepreg material 10 and a second portion disposed on a left side of the first prepreg material 10, and with the first prepreg material 10, the first 30 and second 40 connectors buried in the second prepreg material 50, and the bladder 20. 2) heat-pressing the first 10 and second 50 prepreg materials, the first 30 and second 40 connectors, and the bladder 20.

Based on the forgoing, the crank of the present invention is strong because the first prepreg material 10 is disposed between the first 30 and second 40 connectors and the first prepreg material 10 is symmetrically disposed with respect to the center line A.

Furthermore, the crank is light-weight because the bladder 20 saves the weight of the crank.

Furthermore, the crank is light-weight because the second prepreg material 50 is used to cover up the prepreg material 10 and the first 30 and second 40 connectors.

While the specific embodiments have been illustrated and described, numerous modifications are possible without significantly departing from the spirit of invention, and the scope of invention is limited only by the scope of the accompanying claims.

What is claimed is:

1. A method for making a crank of a bicycle comprising:
preparing a first prepreg material and a second prepreg material, a first connector and a second connector, and a bladder in a mold insert, with the first and second connectors separate from each other, with the first and second connectors buried in the first prepreg material and the first prepreg material including an extension therebetween, with the bladder curved around the first prepreg material and the first and second connectors and having a first portion disposed on a right side of the first prepreg material and a second portion disposed on a left side of the first prepreg material, and with the first prepreg material, the first and second connectors, and the bladder buried in the second prepreg material; and
heat-pressing the first and second prepreg materials, the first and second connectors, and the bladder.

2. The method as claimed in claim 1 wherein the first prepreg material encompasses a respective outer periphery of the first and second connectors in order that the prepreg material and the first and second connectors have a sufficient joining area to prevent detachment therebetween, and wherein the extension of the prepreg material not only supports the first and second connectors but prevents the crank against buckling.

3. The method as claimed in claim 1 wherein the bladder has an inlet opening and an outlet opening, and with the inlet and outlet openings expose towards the same direction.

4. The method as claimed in claim 1, wherein the bladder has an inner peripheral face pressing the first prepreg material so as to make the first prepreg material symmetrically disposed with respect to a center line A, and wherein the bladder has an outer peripheral face urging the second prepreg material to abut against the mold insert.

5. The method as claimed in claim 1, wherein the first and second connectors are connectable with a transmission gear of a bicycle and a pedal, respectively.

6. The method as claimed in claim 1 wherein the second prepreg material has a gap at the inlet and the outlet openings of the bladder.

7. The method as claimed in claim 6 further comprising preparing an additional prepreg material for blocking the gap.

8. The method as claimed in claim 4 wherein air is pumped continually into the bladder and inflates the bladder during the heat-pressing process.
